(19) United States
(12) Patent Application Publication
(10) Pub. No.: US 2004/0108260 A1
(43) Pub. Date: Jun. 10, 2004

(54) Filter assembly for washing machine

(75) Inventor: Il Rog Heo, Changwon-si (KR)

Correspondence Address: FLESHNER & KIM, LLP, P.O. BOX 221200, CHANTILLY, VA, 20153, US

(73) Assignee: LG Electronics, Inc.

(21) Appl. No.: 10/720,392

(22) Filed: Nov. 25, 2003

(30) Foreign Application Priority Data
Nov. 28, 2002 (KR) P2002-75030

(51) Int. Cl. B01D 35/02

(52) U.S. Cl. 210/171; 210/454

(57) ABSTRACT

The present invention relates to a filter assembly for a washing machine having a simple structure to separate dirt or particles involved in water. The present invention includes a filter case and a filter loaded in the filter case. The filter case includes inlet and outlet on a circumference and an opening inside to make the inlet and outlet communicate with each other. And, the filter includes a cap fitted to the filter case, a shaft extending from a bottom of the cap, and an extension extending from an end of the shaft, the extension disposed to confront the opening to filter particles in water, the extension having a protrusion protruding from one side opposite to the cap.

This application claims the benefit of Korean Application No. 10-2002-0075030 filed on Nov. 28, 2002, which is/are hereby incorporated by reference.

### BACKGROUND OF THE INVENTION

1. Field of the Invention

The present invention relates to a washing machine, and more particularly, to a filter assembly for a washing machine having a simple structure to separate dirt or particles involved in washing water using a centrifugal force.

2. Discussion of the Related Art

Generally, a washing machine is an apparatus for removing contaminating particles attached to the laundry, e.g., clothes, linen, etc., using reaction between water and detergent.

Such a washing machine is categorized into an agitator type, a pulsator type and a drum type. The agitator type washing machine rotates a washing rod protruding upward from a bottom center of a tub clockwise and counterclockwise. The pulsator type washing machine performs a washing step using a frictional force between a current, which is generated from a disc type pulsator rotating on a bottom of a washing tub clockwise and counterclockwise, and the laundry. And, the drum type washing machine performs a washing step by putting the laundry, detergent, and water in a drum having a plurality of protruding tumbling ribs form its inner surface and by rotating the drum at a low rotational speed.

If the washing step is performed using one of the various type washing machines, the dirt or particles are separated from the laundry. Lots of particles are accordingly contained in the used water after completion of the washing step.

Meanwhile, the used water is generally discharged outside using a drain pump. In such a case, such particles as lint and the like are frequently stuck to an impeller of the drain pump or a motor shaft, whereby drain capacity of the washing machine is lowered, noise takes place, and the drain pump can be out of order in severe case.

### SUMMARY OF THE INVENTION

Accordingly, the present invention is directed to a filter assembly for a washing machine that substantially obviates one or more of the problems due to limitations and disadvantages of the related art.

An object of the present invention, which has been devised to solve the foregoing problem, lies in providing a filter assembly for a washing machine, by which dirt or particles involved in washing water can be removed as well as an improved structure enabling to form a failure-free filter in one body.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a filter assembly for a washing machine including a filter case and a filter loaded in the filter case. The filter case includes inlet and outlet on a circumference and an opening inside to make the inlet and outlet communicate with each other. And, the filter includes a cap fitted to the filter case, a shaft extending from a bottom of the cap, and an extension extending from an end of the shaft, the extension disposed to confront the opening to filter particles in water, the extension having a protrusion protruding from one side opposite to the cap.

A circumferential cross-section of the protrusion is a closed curve. Preferably, the protrusion has a ring type circumferential cross-section.

The extension has a funnel figure. And, a diameter of an end portion of the extension is equal to or greater than a diameter of the opening.

The filter includes a tube having the inlet and outlet on the circumference, a partition wall provided in the tube to partition an internal space of the tube into first and second chambers communicating with the inlet and outlet, respectively, and the opening perforating the partition wall.

The filter case is cylindrical. And, the inlet is provided to the circumference of the filter case in a tangential direction.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a washing machine according to the present invention;

FIG. 2 is a cross-sectional view of a washing machine according to the present invention;

FIG. 3 is a cross-sectional view of a filter assembly according to a first embodiment of the present invention;

FIG. 4 is a perspective view of a filter of a filter assembly in FIG. 3;

FIG. 5 is a cross-sectional view of a filter assembly according to a second embodiment of the present invention;

FIG. 6 is a perspective view of a filter of a filter assembly in FIG. 5; and

FIG. 7A and FIG. 7B are cross-sectional views of a mold for forming a filter in FIG. 6.

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

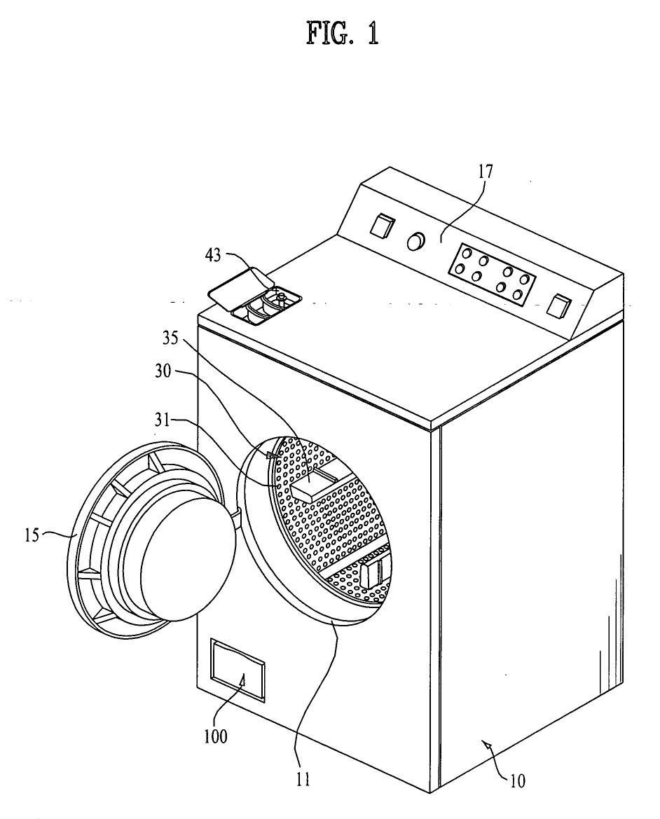

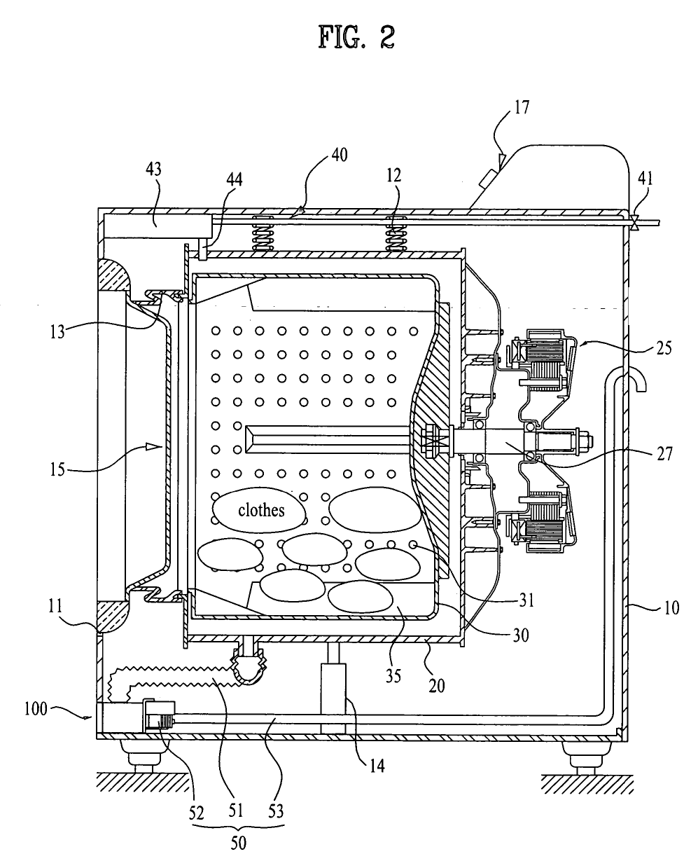

FIG. 1 is a perspective view of a washing machine according to the present invention and FIG. 2 is a cross-sectional view of a washing machine according to the present invention, in which a drum type washing machine is illustrated. Yet, the present invention can be equivalently implemented for the agitator and pulsator type washing machines as well as the drum type.

Referring to FIG. 1 and FIG. 2, a tub 20 is suspended in a cabinet 10. For this, a top of the tub 20 is connected to a spring 12 fixed to the cabinet 10 and a bottom of the tub 20 is connected to a damper 14 hinge-coupled to a bottom of the cabinet 10. The provided spring and damper 12 and 14 plays a role in suspending the tub in the cabinet 10 elastically as well as attenuating vibration applied to the tub 20 while a washing machine operates.

A drum 30 is rotatably provided in the tub 20. For this, a motor 25 is provided in the cabinet, and more specifically, in rear of the tub 20 and the drum 30 is connected to the motor 25 through a shaft 27.

A multitude of perforated holes 31 perforate into a circumference of the drum 30 and a plurality of tumbling ribs 35 are provided on an inner circumference of the drum 30. Hence, water supplied to the tub 20 enables to communicate between the drum 30 and the tub 20 via the perforated holes 31. A laundry having put in the drum 30 is lifted up by the tumbling ribs 35 and then falls down while the drum 30 rotates. Hence, a sufficient frictional and shock energy can be sufficiently provided for washing when the laundry falls down.

An entrance 11 is provided at a front side of the cabinet 10 so that the laundry is put in or out of the drum 30 and a door 15 is provided to open/close the entrance 11. A gasket 13, as shown in FIG. 2, is provided between the entrance 11 and an opening of the tub 20 to prevent the water held in the drum and tub 30 and 20 from leaking. Meanwhile, a control panel 17 is provided on one side, e.g., a top, of the cabinet 10 so that a user controls the washing machine.

A water supply equipment 40 and a drain equipment 50 are provided in the cabinet 10. The water supply equipment 40 includes an inlet valve 41, an inlet hose 42, a detergent box 43, and an inlet bellows 44. The inlet valve 41 turns on or off a passage of water supplied from outside, and the inlet hose 42 connects the inlet valve 41 to the detergent box 43. And, the inlet bellows 44 connects the detergent box 43 to the tub 20. Hence, when the inlet valve 41 is turned on, the water is supplied to the tub 20 via the inlet hose 42, detergent box 43, and inlet bellows 44. In this case, the detergent stored in the detergent box 43 is supplied to the water if necessary.

The drain equipment 50 includes a drain bellows 51, a drain pump 52, and a drain hose 53. The drain bellows 51 connects the tub 20 to the drain pump 52. One end of the drain hose 53 is connected to the drain pump 52, and the other end of the drain hose 53 communicates with an external atmosphere. Hence, once the drain pump 52 operates, the water in the tub 20 is discharged via the drain bellows 51, drain pump 52, and drain hose 53.

A filter assembly 100, as shown in FIG. 1 and FIG. 2, for removing particles contained in the washing water is provided to the washing machine according to the present invention. The filter assembly 100 is provided between the drain bellows 51 and the drain pump 52.

When the drain equipment 50 discharges the water in the tub 20 after completion of washing or rinsing, the filter assembly 100 filters the particles involved in the washing water. When the washing or rinsing is in progress, the filter assembly 100, the filter assembly 100 filters the particles included in the water pumped over the tub 20 by a circulation pump (not shown in the drawing) as well. In doing so, the pumped water falls into the drum 30 to enhance the washing and rinsing power thereof.

The filter assembly 100 of the washing machine according to the present invention filters the particles included in the washing water, thereby enabling to prevent the drain or circulation pimp from being out of order or making noise. A structure of the filter assembly 100 playing such roles is explained in detail as follows.

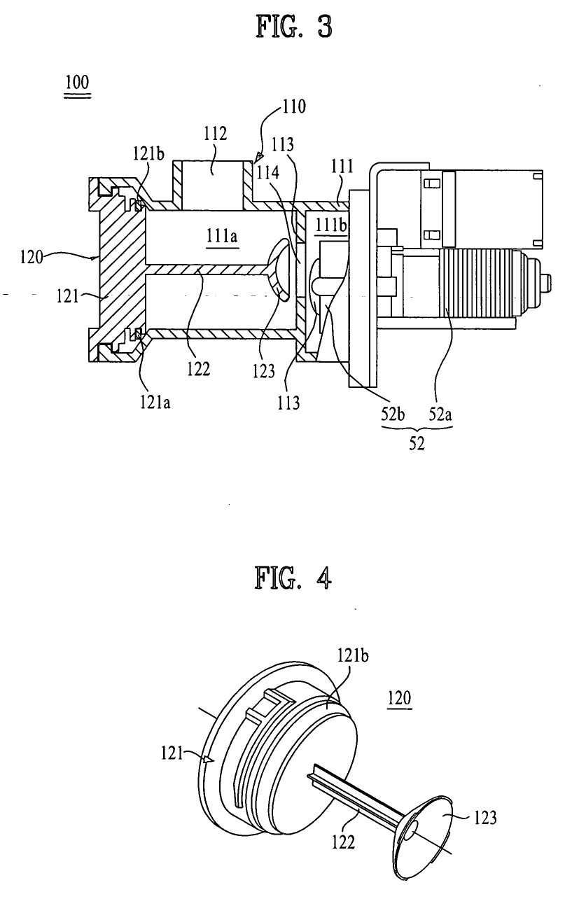

FIG. 3 is a cross-sectional view of a filter assembly according to a first embodiment of the present invention and FIG. 4 is a perspective view of a filter of a filter assembly in FIG. 3.

Referring to FIG. 3 and FIG. 4, a filter assembly 100 according to a first embodiment of the present invention includes a filter case 110 and a filter 120.

First of all, the filter case 110 includes a tube 111, a partition wall 113, and an opening 114. Both ends of the tube 111 are open, and an inlet 112 and an outlet 113 are provided on an outer circumference of the tube 111. The inlet 112 communicates with the tub 20. On draining, water in the tub 20 and the drum 30 flows into the tube 111 via the inlet 112.

The partition wall 113 is provided in the tube 111 to partition an internal space of the tube 111 into a first chamber 111a and a second chamber 111b. The first chamber 111a communicates with the inlet 112 and the second chamber 111b communicates with the outlet 113. Of course, the both open ends of the tube 111, as shown in FIG. 3, communicate with the first and second chambers 111a and 111b, respectively.

The opening 114 is provided to perforate the partition wall 113. The water flowing into the first chamber 111a via the inlet 112 passes through the opening 114 and the second chamber 111b to be discharged outside via the outlet 113.

And, the drain pump 52 is mounted on one of two ends of the filter case 110. The drain pump 52 includes a motor 52a and an impeller 52b. The impeller 52b rotated by the motor 52a is mounted to be disposed in the second chamber 111b.

Meanwhile, the filter 120, as shown in FIG. 3 and FIG. 3, includes a cap 121, a shaft 122, and an extension 123.

The cap 121 is fitted to the tube 111 to be brought contact with the first chamber 111a. In this case, at least one sealing 121b is provided on an outer circumference of the cap 121. The sealing 121b prevents water in the first chamber 111a from leaking when the cap 121 is fitted to the tube 31 to be fixed thereto. Thus, since at least one groove 121a should be provided on the circumference of the cap 121 to be coupled to the sealing 121b, a figure of the cap 121 becomes complicated.

The shaft 122 extends from the cap 121 toward the opening 114. Preferably, the shaft 122 is disposed along a central axis of the tube 111 of the filter case 110.

The extension 123 extends from a circumference of an end of the shaft 122. The extension 123 is disposed to leave a predetermined gap from the opening 114 to confront the partition wall 113. Hence, the water in the first chamber 11a enables to flow in the opening 114 through the gap.

A size of the extension 123 in the filter assembly 100 is preferably greater than that of the opening 114. And, a rim of the opening 114, as shown in FIG. 3, is preferably overlapped with an edge of the extension 123. Namely, when the extension 123 is viewed from a side of the cap 121, the extension 123 is preferably disposed so that the opening 114 is blocked by the extension 123 not to be seen. This is to effectively prevent the particles, which are moving toward the opening 114 in a direction of the shaft 122 from the first chamber 11a in FIG. 3 and are blocked by the extension 123, from flowing in the opening 114.

The above-constructed filter assembly 100 removes the particles using a centrifugal force, of which principle is explained as follows.

First of all, water having flown in the first chamber 111a via the inlet 112 whirls along an inner circumference of the tube 111 to move toward the second chamber 111b. When the turning water forms a whirl, particles gather toward a center of the whirl but the water is pushed toward an inner wall of the tube 111. The particles gathering around the center of the whirl are blocked by the extension 123 to remain in the first chamber 111a, whereas the water in the circumferential area of the whirl flows in the second chamber 111b through the gap.

Meanwhile, in the filter assembly 110, the water having flown in the first chamber 111a should easily form the whirl. Hence, the tube 111, and more particularly, side of the first chamber 111a is preferably formed cylindrical. Furthermore, the inlet 112 is preferably formed on an outer circumference of the tube 111 along a tangential direction thereof. And, the extension 123, as shown in FIG. 3 and FIG. 4 preferably has a shape of a funnel.

Meanwhile, the filter 120 of the filter assembly 100 is very simply structured. Hence, the filter 120 is built in one body.

In forming the filter 120 in one body, three separate molds are used. First and second molds are coupled to each other right and left and a third mold is coupled to bottoms of the first and second molds. One cavity provided by the first and second molds contours the cap 121 of the filter 120, the shaft 121, ad an upper surface of the extension 123 and the other cavity provided by the third mold contours a bottom of the extension 123.

After die-casting the filter 120, the first and second molds are separated from each other. The filter 120 is then separated from the third mold. Yet, at least one grove 121a should be provided to the circumference of the cap 121 of the filter 120, whereby overall shapes of the first and second molds become considerably complicated. When the first and second molds are separated from each other, the cap 121 of the filter 120 keeping adhering to one of the first and second molds may be separated form the third mold, whereby failure takes place frequently.

To prevent such a problem, a structural improvement is needed to maintain the state of the filter 120 while the first and second molds are detached.

A second embodiment of the present invention is provided to overcome such a problem.

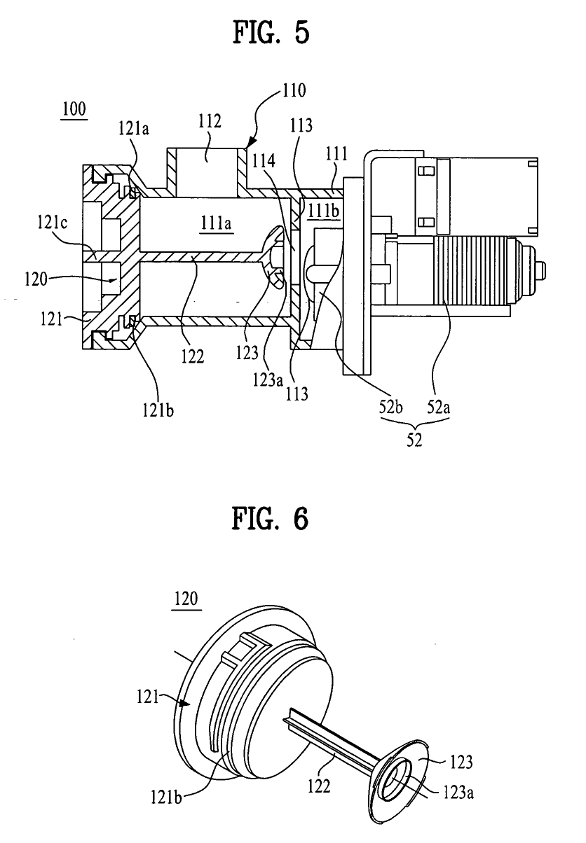

FIG. 5 is a cross-sectional view of a filter assembly according to a second embodiment of the present invention and FIG. 6 is a perspective view of a filter of a filter assembly in FIG. 5.

Referring to FIG. 5 and FIG. 6, a filter assembly 100 according to a second embodiment of the present invention includes a filter case 110 and a filter 120. A construction of the filter case 110 according to the second embodiment of the present invention in FIG. 3 and FIG. 4 is closely similar to that of the first embodiment of the present invention, whereby its description is skipped. And, the filter 120 according to the second embodiment of the present invention in FIG. 3 and FIG. 4 is equivalent to that of the first embodiment of the present invention except that a protrusion 123a is further provided to the extension 123. A special feature of the second embodiment according to the present invention is explained in brief by referring to FIG. 5 and FIG. 6 as follows.

The protrusion 123a, as shown in FIG. 5 and FIG. 6, protrudes from one side of the extension 123 in an opposite direction to the cap 121. A cross-section of the protrusion 123a bisected in a circumferential direction forms a closed curve. For instance, such a circumferential cross-section, as shown in FIG. 6, has a ring type.

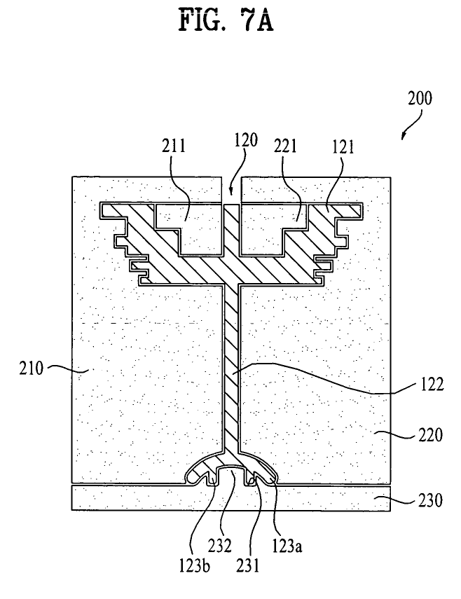

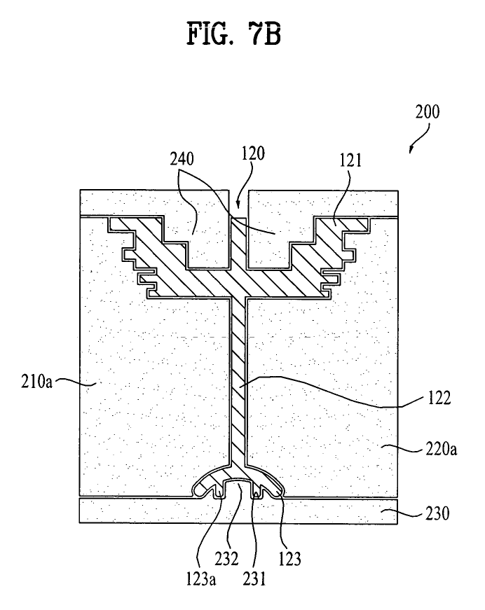

If the protrusion 123a having the ring type circumferential cross-section is provided to the extension 123, the protrusion 123a maintains to be attached to the mold forming the bottom of the extension 123 when the other molds forming the cap 121 and shaft 122 of the filter 120 are separated from each other. Hence, the molds are separated while the filter 120 keeps its position, whereby a poor result of the filter 120 is prevented. Such a mechanism is briefly explained by referring to FIG. 7A and FIG. 7B as follows.

FIG. 7A shows an exemplary mold for forming the filter according to the second embodiment of the present invention.

Referring to FIG. 7A, in order to form the filter 120, three molds and one or two cores 211 are used. A first mold 210 and a second mold 220 are coupled to each other in a horizontal direction to form the cap 121, the shaft 122, and an upper side of the extension 123. In this case, one or two cores 211 are provided to a portion of a cavity corresponding to an upper side of the cap 121. And, a third mold 230 is provided beneath the first and second molds 210 and 220 to form a lower side of the extension 123. Of course, a groove 231 is provided to the third mold 230 to form the protrusion 123a. In this case, since the groove 231 is a ring type, a projection 232 is formed on a center of the groove 231.

After forming the filter 120 using the above-constructed molds, when the first and second molds 210 and 220 are separated from each other, the protrusion 123a is stuck in the groove 231 of the third mold 230 and the projection 232 of the third mold 230 is fitted to the protrusion 123a. Hence, while the filter 120 maintains its position, the first and second molds 210 and 220 can be separated from each other to prevent the poor result of the filter 120. After separating the first and second molds 210 and 220, the core 211 is detached. The filter 120 is then pushed upward to be separated from the third mold 230.

FIG. 7B shows another exemplary mold for forming the filter 210 according to the second embodiment of the present invention.

Referring to FIG. 7B, in order to form the filter 120, four molds are used. A first mold 210a and a second mold 220a form upper and lower sides of the cap 121, the shaft 122, and an upper side of the extension 123. A third mold 230 forms a lower side of the extension 123. And, the fourth mold 240 forms an upper side of the cap 121.

IN this case, the third mold 230 has the same shape of that in FIG. 7A. Hence, when the first and second molds 210a and 220a are separated, the filter 120 can maintain its position to prevent a poor result. Moreover, the fourth mold 240 moves upward to be detached from the filter 120.

Meanwhile, the filter 120 according to the second embodiment of the present invention can be prepared using various type molds including the examples in FIG. 7A and FIG. 7B. In doing so, the groove 231 corresponding to the protrusion 123a is further provided just to the mold playing a role of the third mold 230.

An operation of the washing machine according to the present invention is explained as follows.

First of all, a laundry is put in the drum 30, the door 15 is closed, and the control panel 17 is operated, in turn. After operation of the control panel 110, the water supply equipment 40 appropriately supplies water and detergent to the drum 30. While the drum 30 rotates, the laundry is lifted up by the tumbling ribs 35 to fall. The circulation pump pumps the water over the tub 20 and the pumped water falls into the drum 30 to enhance washing power.

After completion of washing, the rain equipment 50 discharges the used water in the drum 30 and the tub 20 outside. In doing so, the filter assembly 100 filters the particles included in the used water. Of course, the filter assembly 100 filters another particles in the water pumped by the circulation pump as well. Such a process is explained in brief.

First of all, once the circulation or drain pump is driven, the water in the drum 30 and tub 20 flows in the first chamber 11a via the inlet 112. In doing so, the water revolves centering around the shaft 122 in the first chamber 11a to form a whirl.

The whirling water moves toward the opening 114. In doing so, by the centrifugal force, clean water moves outside the whirl and particles moves inside the whirl. Hence, the extension 123 prevents the particles inside the whirls from flowing in the opening 114, whereby the particles remain in the first chamber 111a. Yet, the water outside the whirl flows in the opening 114 via the gap.

In the mean time, a small amount of the particles remaining in the circumferential area of the whirl fails to pass the gap between the extension 123 and the opening 114 but is filtered. This is because most of the particles are lint that is unable to pass through the narrow gap with ease. Hence, only the water of which particles are filtered comes into flowing in the second chamber 111b.

Besides, the particles remaining in the first chamber 111a is wound around the shaft 122. Furthermore, other particles moving in the central direction of the whirl keep being entangled with the shaft-wound particles to be easily separated from the water. Moreover, the particles failing to pas the narrow gap are attached to the edge of the extension 123. After long time use of the filter assembly, the filter 120 is pulled out to be cleaned and is then loaded in the filter case 110 to use.

After completion of draining, the water supply equipment supplies water to the drum 30. The drum 30 then rotates to rinse the laundry. The drain equipment 50 then discharges the rinsing water outside. Such a rinsing step is repeated at least once.

After completion of rinsing, the drum 30 rotates at high sped. The corresponding centrifugal force separates water contents from the laundry. After completion of dewatering, the user pulls out the washed and dewatered laundry through the door 15.

Besides, if a drying function is provided to the washing machine, hot air is blown to the drum 30 to completely dry the laundry.

The washing machine including the filter assembly according to the present invention has the following advantages or effects.

First of all, the particles involved in the water are removed on draining, whereby operational failure, breakdown, and noise of the drain pump can be prevented.

Secondly, the filter of the filter assembly according to the present invention has such a simple structure that can be formed in one body. Therefore, the present invention reduces product cost and enhances productivity.

Finally, the protrusion provided to the extension of the filter enables to separate the molds while the filter maintains its position, whereby the poor result of the filter generated from separating the molds from the filter can be prevented. Therefore, productivity is improved as well as the product cost is reduced.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A filter for a washing machine, comprising:
a cap fitted to a filter case having an opening via which water passes;
a shaft extending from a bottom of the cap; and
an extension extending from an end of the shaft, the extension disposed to confront the opening to filter particles included in the water, the extension having a protrusion protruding from one side opposite to the cap.

2. The filter as claimed in claim 1, wherein a circumferential cross-section of the protrusion is a closed curve.

3. The filter as claimed in claim 1, wherein the protrusion has a ring type circumferential cross-section.

4. The filter as claimed in claim 1, wherein the extension has a funnel figure.

5. The filter as claimed in claim 1, wherein a diameter of an end portion of the extension is equal to or greater than a diameter of the opening.

6. A filter assembly for a washing machine, comprising:
a filter case comprising:
inlet and outlet on a circumference; and
an opening inside to make the inlet and outlet communicate with each other; and
a filter loaded in the filter case, the filter comprising:
a cap fitted to the filter case;
a shaft extending from a bottom of the cap; and
an extension extending from an end of the shaft, the extension disposed to confront the opening to filter particles in water, the extension having a protrusion protruding from one side opposite to the cap.

7. The filter assembly as claimed in claim 6, wherein a circumferential cross-section of the protrusion is a closed curve.

8. The filter assembly as claimed in claim 6, wherein the protrusion has a ring type circumferential cross-section.

9. The filter assembly as claimed in claim 6, wherein the extension has a funnel figure.

10. The filter assembly as claimed in claim 6, wherein a diameter of an end portion of the extension is equal to or greater than a diameter of the opening.

11. The filter assembly as claimed in claim 6, wherein the filter case is cylindrical.

12. The filter assembly as claimed in claim 6, wherein the inlet is provided to the circumference of the filter case in a tangential direction.

13. The filter assembly of claim 6, wherein the filter case comprises:
a tube having the inlet and outlet on the circumference;
a partition wall provided in the tube to partition an internal space of the tube into first and second chambers communicating with the inlet and outlet, respectively; and
the opening perforating the partition wall.

14. A washing machine comprising:
a cabinet;
a tub provided in the cabinet;
a drum rotatably installed in the tub;
a filter assembly provided in the cabinet to filter water discharged from the tub, the filter assembly comprising:
a filter case comprising:
inlet and outlet on a circumference; and
an opening inside to make the inlet and outlet communicate with each other; and
a filter loaded in the filter case, the filter comprising:
a cap fitted to the filter case;
a shaft extending from a bottom of the cap; and
an extension extending from an end of the shaft, the extension disposed to confront the opening to filter particles in the water, the extension having a protrusion protruding from one side opposite to the cap.

15. The washing machine as claimed in claim 14, wherein a circumferential cross-section of the protrusion is a closed curve.

16. The washing machine as claimed in claim 14, wherein the protrusion has a ring type circumferential cross-section.

17. The washing machine as claimed in claim 14, wherein the extension has a funnel figure.

18. The washing machine as claimed in claim 14, wherein a diameter of an end portion of the extension is equal to or greater than a diameter of the opening.

19. The washing machine as claimed in claim 14, wherein the filter case is cylindrical.

20. The washing machine as claimed in claim 19, wherein the inlet is provided to the circumference of the filter case in a tangential direction.

21. The washing machine of claim 14, wherein the filter case comprises:
a tube having the inlet and outlet on the circumference;
a partition wall provided in the tube to partition an internal space of the tube into first and second chambers communicating with the inlet and outlet, respectively; and
the opening perforating the partition wall.
